(19) United States
(12) Patent Application Publication
(10) Pub. No.: US 2003/0117815 A1
(43) Pub. Date: Jun. 26, 2003

(54) Method and device for reducing harmonics in power converters

(76) Inventor: Johnny Bou Saada, Brussels (BE)

Correspondence Address: KNOBBE MARTENS OLSON & BEAR LLP, 2040 MAIN STREET, FOURTEENTH FLOOR, IRVINE, CA, 92614, US

(21) Appl. No.: 10/221,584

(22) PCT Filed: Mar. 13, 2001
(86) PCT No.: PCT/BE01/00044

(30) Foreign Application Priority Data
Mar. 13, 2000 (EP) 00870042.9

(51) Int. Cl. H02M 1/12

(52) U.S. Cl. 363/40

(57) ABSTRACT

The invention concerns multistage power switching electronic device for reducing undesirable harmonics amplitudes generated in said device, in particular in the form of beats, comprising at least an input filter, a rheostatic braking chopper including at least two switches and multilevel static converter including at least four switches in series. Aspects of the invention may be characterized by the oscillator being directly attached to the chopper providing a connection by their midpoint and a variable random frequency pulse generator which controls the switches of the chopper.

### SUBJECT OF THE INVENTION

The present invention relates to a device and a process for reducing interfering harmonics generated in a power converter.

### STATE OF THE ART

Power electronics generally work by switches, which leads to the creation of harmonics. Furthermore, a power system consists of sub-systems, each working at its own frequency. The combination of these various frequencies is the source of harmonics by the phenomenon of beating.

A beat is the periodic variation in the amplitude of an oscillation resulting from the superposition of two neighbouring frequencies.

Generally, it is sought to decouple these sub-systems by using filters comprising inductors (L) and capacitors (C).

In the case of three-phase inverters for propulsion engines in railway applications, for example, a treatment of PWM waves by set wave correction in a discriminator has moreover been proposed (publication WO 96/33548). This process makes it possible to eliminate the dead times in the switching set waves and thus to significantly reduce the undesirable harmonics, in particular the 5th and 7th order harmonics appearing in the engine currents and the 6th order harmonics appearing on the power supply side and on the engine torque side.

However, changing the configuration of the system is often limited by the losses of semiconductors or by the physics of the system.

A large number of documents, and among them the documents U.S. Pat. No. 4,638,417, DE-A-196 51 281, DE-A-3 912 706, GB-A-2 232 835 and U.S. Pat. No. 4,339,697, have proposed to apply a set wave that is variable, and in certain cases of random frequency, to PWM waves intended to control the inverter, essentially with the aim of reducing noise.

### AIMS OF THE INVENTION

The present invention is directed towards proposing a simple device for reducing, or even eliminating, the harmonics originating from the composition of the different switching frequencies in multistage power converters.

The present invention is directed in particular towards proposing a device and a process that can be applied to a system comprising at least two of the following functional sub-systems: rheostatic braking chopper, inverter/rectifier.

### MAIN CHARACTERISTIC ELEMENTS OF THE INVENTION

The present invention relates to a device and a process for reducing the amplitudes of undesirable harmonics in multistage switching power converters, in which the switch(es) of at least one of the said stages is (are) controlled by pulses of variable random frequency.

According to the invention, the term “power converter” means a power switching device consisting of several functional sub-systems comprising an input filter, a rheostatic braking chopper and a multilevel inverter or rectifier.

Conventionally, the chopper consists of at least two switches, preferably of IGBT type and arranged in series, each being arranged in parallel with a diode arranged in reverse bias, the switch/reverse-bias diode assembly being in series with a resistor.

Conventionally, one arm of a multilevel inverter, for example of a three-level inverter, consists of at least four switches, preferably of IGBT type, coupled in pairs. Each switch is in parallel with a reverse-bias diode.

According to the invention, it is the chopper switches that will be controlled by variable random-frequency pulses.

Thus, the device according to the present invention comprises a wave generator consisting of variable random-frequency pulses intended to control the chopper switches.

Preferably, the frequency obeys a Gaussian distribution, the standard deviation of which is between 15% and 35% of the mean.

Advantageously, the mean corresponds to the fixed frequency usually used for controlling the switches under consideration.

According to one particular example, the mean control frequency of the chopper is between 600 and 900 Hz and the standard deviation is between 150 and 250 Hz.

According to one important characteristic of the present invention, the multilevel inverter is directly attached to the chopper, i.e. the chopper will be connected to the inverter via its midpoint.

This means that it is thus possible to avoid the presence of a separate intermediate capacitor voltage divider for the chopper.

### BRIEF DESCRIPTION OF THE DRAWINGS

FIG. 1 represents the circuit diagram of a two-stage converter according to the state of the art.

FIG. 2 represents the circuit diagram of a converter using the device and the process for reducing harmonics according to the present invention.

FIG. 3 represents a waveform applied to an inverter control, with three switching angles α1, α2 and α3.

FIG. 4 represents the control signal, with its set wave signal, applied to the rheostatic braking chopper according to the invention.

### DESCRIPTION OF THE STATE OF THE ART

FIG. 1 represents a two-stage converter according to the state of the art. It consists conventionally of several sub-assemblies: input filter 1, braking chopper 2 and inverter 4. Only one arm of a three-level inverter has been represented in the present case.

Conventionally, the input filter consists of an inductor L and one or more capacitors C3 and C4.

The braking chopper 2 consists of two switches Fr1 and Fr2, preferably of IGBT type and arranged in series, each of these switches being in parallel with a reverse-bias diode Dr1 and Dr2, the switch/reverse-bias diode assembly being in series with a resistor R1 and R2 which allows dissipation of the energy that is not consumed by the load M1.

In addition, to ensure the voltage strength, a capacitor voltage divider for the chopper consisting of two capacitors C3 and C4 is provided.

One arm of a three-level inverter is represented conventionally in FIG. 1. It consists of four switches, preferably of IGBT type, coupled in pairs (T1 and T2, T3 and T4). On each switch is arranged in parallel a reverse-bias diode D1 to D4. A capacitor voltage divider 3 consisting of the two capacitors C1 and C2 is also arranged in parallel on the inverter 4.

As will be seen in FIG. 1, usually, the midpoints of the chopper X′ and X are, according to the state of the art, not connected.

### DESCRIPTION OF ONE PREFERRED EMBODIMENT OF THE INVENTION

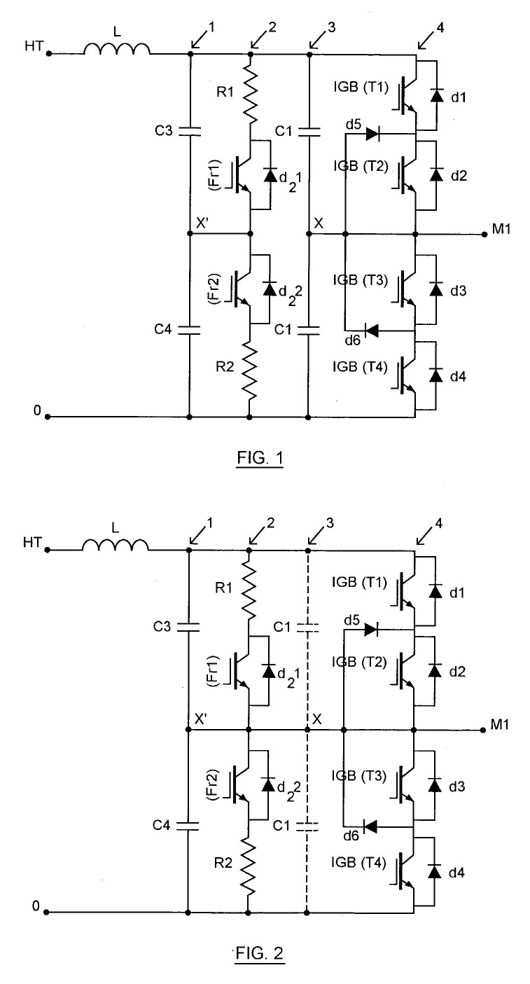

According to the present invention, as represented in FIG. 2, it is proposed to connect the midpoints of the chopper and of the inverter, respectively (X and X′), arranged accordingly between the two capacitors. This makes it possible, in a particularly advantageous manner, to no longer need to provide a capacitor voltage divider bridge specific to each of the chopper 2/inverter 4 sub-systems.

The mode of functioning of the three-level inverter 4 is entirely conventional and makes it possible to distribute the HT direct voltage of the overhead contact line over two IGBT switches by making them conduct in pairs, first the top two (IGBT1, IGBT2), then the middle two (IGBT2, IGBT3) and finally the bottom two (IGBT3, IGBT4).

The approximation of a sinusoidal curve is thus made by three voltage levels: HT, HT/2 and 0.

A second capacitor voltage divider is thus no longer necessary to set the intermediate potential and thus for the correct functioning of the inverter, since the connection between the midpoints X, X′ allows a good distribution of the high voltage.

Compared with a two-level inverter, the three-level system already makes it possible to reduce the level of harmonics, via a better approximation of the sinusoidal curve.

As the voltage supplied by the inverter to the load is symmetrical relative to the axis Oy, the development in the Fourier series comprises only the fundamental and odd harmonics (3rd, 5th, 7th, 9th, etc. order):

HT (t)=α₁sin (ωt+φ₁)+α₃sin (3ωt+φ₃)+α₅sin (5ωt+φ₅)+ . . .

in which t is the time, ω is the fundamental angular frequency and φ₂ᵢ₋₁ is the phase corresponding to the frequency (2i−1)ω, i=1, 2, 3, . . .

It may be shown that it is possible to obtain a system of n linear equations with n unknowns in which the coefficients a₃, a₅, a₇, . . . are expressed as a function of the switching angles α₁, α₂, α₃, . . . FIG. 2 shows a waveform corresponding to three switching angles α₁, α₂, α₃.

By inverting the system of equations, the switching angles α₁, α₂, α₃, . . . can then expressed as a function of the coefficients of the development in the Fourier series a₃, a₅, a₇, . . .

It is thus possible to calculate the switching angles required to eliminate certain harmonics, chosen from the start. In other words, the astute choice of the waveform applied to the inverter sub-system makes it possible to eliminate, on the engine side, certain harmonics, and in particular the most undesirable such as the 5th and 7th order harmonics. The harmonics of 3rd order and multiples of 3 are not an inconvenience on the engine side since it is a matter in this case of a three-phase system with an insulated neutral.

Usually, it is sought not to incorporate the capacitor bridge 3 (C1, C2) and, as far as possible, to have the braking chopper directly connected to the inverter (X=X′). In this case, beating is inevitable and will be suppressed only if a command is provided from the chopper, as described below.

During normal functioning, the inverter thus generates at the midpoint X, X′ harmonics whose frequencies are multiples of 3 of the working frequency. For example, if the inverter operates at 50 Hz, the frequencies 150, 300, 450 Hz etc. are found at the midpoint.

In the example given in FIG. 2, the braking chopper, directly attached to the inverter, operates at its own frequency (for example 800 Hz). This frequency is liable to combine with all the harmonics present at the midpoint to form a beat. Needless to say, this beat is proportionately more intense the closer together the frequencies are.

Specifically, if f1 is the harmonic frequency of the inverter and f2 is the frequency of the chopper, two beats are obtained, of frequency(f1+f2)/2 and (f1−f2)/2.

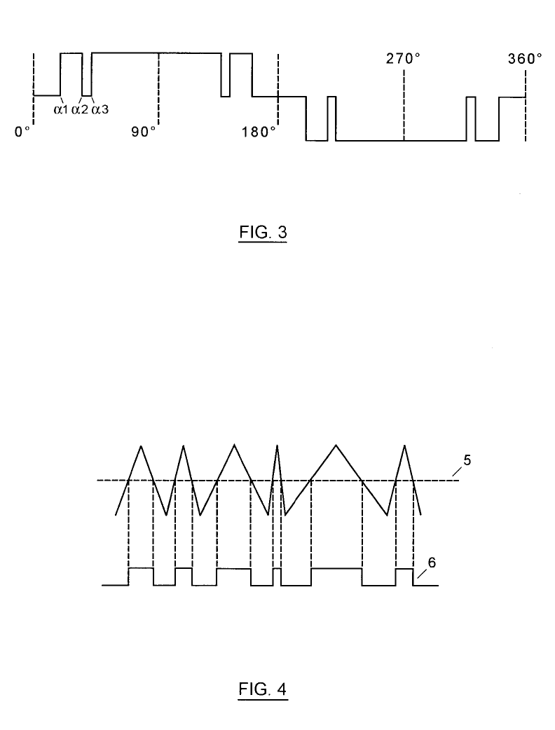

To counter this phenomenon, it suffices to envisage using a random frequency to control the chopper. The distribution of this frequency is, for example, a Gaussian distribution with a mean value equal to the usual working frequency f₀=800 Hz and having a standard deviation of the order of Δf=200 Hz. FIG. 3 gives an example of a control signal 6 for chopper IGBTs (IGBT Fr1, IGBT Fr2), at random frequency. The set wave 5 gives the level of the modulation rate applied to the chopper.

One preferred embodiment of the invention consists in generating an input signal which is a sampling of a sinus function over an interval of finite time (for example one sample every 10 ms over an interval of one second) and the frequency of which changes over time using a random number generator.

Relative to the single frequency, the switching losses in the power components are the same.

The solution recommended by the invention has, however, several important advantages:

reduction of beats that is proportionately larger the greater the standard deviation is;

reduction of the noise of the system;

possible suppression of the capacitor voltage divider between the chopper and the inverter.

1. Electronic multistage power switching device for reducing the amplitudes of undesirable harmonics generated in the said device, in particular in the form of beats, comprising at least one input filter (1), a rheostatic braking chopper (2) comprising at least two switches (Fr1, Fr2) and a multilevel inverter (4) comprising at least four switches in series (T1, T2, T3, T4), characterized in that the inverter (4) is directly attached to the chopper (2) by providing a connection via their midpoint (X=X′) and in that it comprises a variable random-frequency pulse generator controlling the switches of said chopper (2).

2. Device according to claim 1, characterized in that the random frequency obeys a Gaussian distribution of mean frequency equal to the frequency used for an equivalent device at fixed frequency.

3. Device according to claim 1, characterized in that the random frequency obeys a non-Gaussian distribution.

4. Device according to any one of the preceding claims, characterized in that the standard deviation of the distribution is between 15% and 35% of the mean frequency.

5. Device according to any one of the preceding claims, characterized in that the switches of the inverter (4) are controlled by pulses of a PWM wave corresponding to switching angles (α1, α2, α3, . . . ) calculated so as to reduce or eliminate the amplitude of at least one odd harmonic of the voltage waveform supplied by said inverter (4) to a load (M1).

6. Process for reducing the amplitudes of the undesirable harmonics generated in a multistage power switching device, comprising at least one input filter (1), a rheostatic braking chopper (2) comprising at least two switches (Fr1, Fr2) and a multilevel inverter (4) comprising at least four switches (T1, T2, T3, T4), the inverter (4) being directly attached to the chopper (2) via a connection connecting the midpoint (X) of the inverter (4) to the midpoint (X′) of the chopper (2), characterized in that the switches (Fr1, Fr2) of the chopper (2) are controlled by variable random-frequency pulses.
